(19) United States
(12) Patent Application Publication
(10) Pub. No.: US 2024/0313496 A1
(43) Pub. Date: Sep. 19, 2024

(54) LIGHT PULSE GENERATOR IN A CROSS-POLARIZATION CONFIGURATION

(71) Applicants: TERAXION INC., Quebec (CA); UNIVERSITE LAVAL, Quebec (CA)

(72) Inventors: Vincent BOULANGER, Quebec (CA); Pascal DELADURANTAYE, Quebec (CA)

(21) Appl. No.: 18/606,861

(22) Filed: Mar. 15, 2024

Related U.S. Application Data
(60) Provisional application No. 63/490,788, filed on Mar. 17, 2023.

(51) Int. Cl. H01S 3/00; H01S 3/067

(52) U.S. Cl. CPC H01S 3/0057; H01S 3/06712; H01S 3/0675

(57) ABSTRACT

A light pulse generator for generating ultrashort light pulses is provided. The light pulse generator is based on a linear cavity free of polarizing components and configured to generate ultrashort light pulses based on spectral broadening of light. Segments of polarization maintaining fibers define an optical fiber path bound by first and second FBGs. A cross-polarization configuration in the cavity allows to couple a slow polarization axis of the optical fiber segment hosting the first FBG optical fiber segment with a fast polarization axis of the optical fiber segment hosting the second FBG. The cross-polarization configuration takes advantage of the birefringence of FBGs in polarization maintaining optical fibers to ensure a systematic start-up in only one predetermined polarization axis, without the necessity to add a polarizer or other polarizing component in the cavity.

### CROSS REFERENCE TO RELATED APPLICATION

This application claims the benefit of priority under 35 U.S.C. § 119(e) to U.S. Provisional Patent Application No. 63/490,788, filed Mar. 17, 2023, which is incorporated herein by reference in its entirety.

### TECHNICAL FIELD

The technical field generally relates to light pulse generation and concerns a Mamyshev-type linear cavity favoring systematic laser start-up in only one polarization axis, without the necessity to add a polarizer or other polarizing component in the cavity.

### BACKGROUND

Ultrafast fiber laser sources are used in a wide variety of applications across life sciences, industrial and scientific areas. Typical examples of these applications are multiphoton and time-resolved microscopy, femtosecond micromachining, generation of higher harmonics, supercontinuum or terahertz waves and two-photon polymerization. These applications usually rely on a stable source of high-energy ultrashort pulses provided by a low-power femtosecond oscillator amplified by a complex system involving several components and free-space propagation.

To improve the energy of the oscillators and reduce the complexity of the amplifying system, an ultrafast laser architecture named Mamyshev oscillator (MO) was introduced [M. Piché, Proc. SPIE 2041, 358 (1994)] and eventually developed to reach unprecedented peak power levels in ytterbium-doped systems emitting at 1060 nm [Z. Liu, Z. M. Ziegler, L. G. Wright, and F. W. Wise, Optica 4, 649 (2017); W. Liu, R. Liao, J. Zhao, J. Cui, Y. Song, C. Wang, and M. Hu, Optica 6, 194 (2019)]. Such high-energy oscillators were also demonstrated in erbium-doped fibers emitting at 1565 nm [M. Olivier, V. Boulanger, F. Guilbert-Savary, P. Sidorenko, F. W. Wise, and M. Piché, Opt. Lett. 44, 851 (2019)] and thulium-doped fibers emitting at 1965 nm [P. Repgen, B. Schuhbauer, M. Hinkelmann, D. Wandt, A. Wienke, U. Morgner, J. Neumann, and D. Kracht, Opt. Express 28, 13837 (2020)], although the energy at those wavelengths is limited by the availability of optical fibers with normal dispersion and low nonlinearity. Early demonstrations of high-energy MOs were based on ring cavities involving free-space propagation sections to provide more control and facilitate the exploration of the parameters. Linear cavities with free-space segments were also considered for their simplicity.

In addition, the benefits of an all-fiber format are obvious and different groups reported progress in that area. By way of example, Haig et al. [Haig, P. Sidorenko, R. Thorne, and F. Wise, Opt. Lett. 47, 762 (2022)] obtained 80 nJ, 40 fs compressed pulses from a self-starting all-fiber ring cavity MO based on a single 10-μm core Yb fiber segment designed as a gain-managed nonlinear amplifier (GMN).

One outstanding issue about MOs is the control of the polarization of the light pulses outputted by the laser. As known to those skilled in the art, in practice, optical fibers typically exhibit a small degree of birefringence, that is, differences in the phase velocity of light travelling in the principal orthogonal polarization modes, typically designated the Slow Axis (SA) and Fast Axis (FA) modes, leading to crosstalk between these modes. For applications where preserving polarization can be an issue, it is known to use Polarization Maintaining (PM) fiber, in which linearly polarized light, if properly launched into the optical fiber, maintains a linear polarization during propagation with little or no crosstalk between the two polarization modes. After start-up, an MO cavity using PM optical fibers will naturally initiate a pulsed operation in one of the two principal polarization axes of the PM fibers. In the absence of a polarizing element in the cavity, however, either the slow or fast polarization axis SA or FA may be favored for pulse operation.

There remains a need for an improved light pulse generator alleviating at least some of the drawbacks of the prior art.

### SUMMARY

In accordance with some implementations, there is provided a light pulse generator, comprising:
a linear cavity free of polarizing components and configured to generate, based on spectral broadening of light, ultrashort light pulses having a pre-defined polarization, comprising:
   an optical fiber path comprising a plurality of consecutive optical fiber segments each configured to guide polarized light such that the polarization of the polarized light is aligned with one of two orthogonal principal axes;
   first and second Fiber Bragg gratings (FBGs) disposed at opposite extremities of the optical fiber path and respectively hosted in a first and a second FBG-hosting optical fiber segment from said plurality of optical fiber segments, the first and second FBG-hosting optical fiber segments each having a birefringence defining a slow polarization axis and a fast polarization axis as said orthogonal principal axes; and
   at least one optical gain region positioned in the optical fiber path between the FBGs;
wherein the linear cavity is configured such that the slow polarization axis of the first FBG-hosting optical fiber segment is aligned with the fast polarization axis of the second FBG-hosting optical fiber segment.

In some implementations, two or more of the optical fiber segments of the optical fiber path are segments of polarization maintaining optical fibers.

In some implementations, said segments of polarization maintaining optical fibers are PANDA-type fibers, bow-tie fibers, photonic crystal fibers having a birefringence-inducing arrangement of air holes, flattened optical fibers or coiled optical fibers with a birefringence-inducing coiling or combinations thereof.

In some implementations, two consecutive ones of said segments of polarization maintaining optical fibers are coupled together with a 90-degree junction between their respective principal axes. In some implementations, said 90-degree junction is a fusion splice.

In some implementations, said two consecutive ones of the optical fiber segments coupled together with a 90-degree junction are PANDA-type fibers each having a core and a pair of stress rods disposed on opposite sides of said core, said two of the optical fiber segments being aligned along the linear cavity with their respective stress rods at a 90-degree rotation angle relative to each other.

In some implementations, at least one of the optical fiber segments of the optical fiber path is configured to avoid crosstalk between said orthogonal principal axes without inducing birefringence.

In some implementations, the first FBG is a Low Reflectivity FBG (LR-FBG) and the second FBG is a High Reflectivity FBG (HR-FBG), whereas in other implementations, the first FBG is a High Reflectivity FBG (HR-FBG) and the second FBG is a Low Reflectivity FBG (LR-FBG).

In some implementations, the first and second FBGs each have a slow axis reflectivity profile and a fast axis reflectivity profile, a spectral spacing between the slow axis reflectivity profile of the first FBG and the fast axis reflectivity profile of the second FBG being shorter than a spectral spacing between the fast axis reflectivity profile of the first FBG and the slow axis reflectivity profile of the second FBG.

In some implementations, the first FBG has a first reflectivity profile and the second FBG has a second reflectivity profile detuned from the first reflectivity profile, the linear cavity being configured as a Mamyshev Oscillator.

In some implementations, wherein the first and second FBGs each has a corresponding reflective spectral band, the reflective spectral bands of the FBGs substantially overlapping, thereby defining an overlap spectral range, said light pulse generator further comprising a blocking filter positioned between the FBGs and configured to remove light at wavelengths within a blocking spectral range from the optical path, the blocking spectral range including at least the overlap spectral range.

In accordance with another aspect, there is provided a light pulse generator, comprising:
a linear cavity free of polarizing components and configured to generate, based on spectral broadening of light, ultrashort light pulses having a pre-defined polarization, comprising:
   an optical fiber path comprising a plurality of consecutive optical fiber segments each configured to guide polarized light such that the polarization of the polarized light is aligned with one of two orthogonal principal axes, two or more of said optical fiber segments consisting of segments of polarization maintaining optical fibers;
   first and second Fiber Bragg gratings (FBGs) disposed at opposite extremities of the optical fiber path and respectively hosted in a first and a second FBG-hosting optical fiber segment from said plurality of optical fiber segments, at least the first FBG-hosting optical fiber segment being one of said segments of polarization maintaining optical fibers and having a birefringence defining a slow polarization axis and a fast polarization axis as said orthogonal principal axes; and
   at least one optical gain region positioned in the optical fiber path between the FBGs;
wherein two consecutive ones of said segments of polarization maintaining optical fibers are coupled together with a 90-degree junction between their respective principal axes.

In some implementations, said 90-degree junction is a fusion splice.

In some implementations, said segments of polarization maintaining optical fibers are PANDA-type fibers, bow-tie fibers, photonic crystal fibers having a birefringence-inducing arrangement of air holes, flattened optical fibers or coiled optical fibers with a birefringence-inducing coiling or combinations thereof.

In some implementations, said two consecutive ones of said segments of polarization maintaining optical fibers coupled together with a 90-degree junction are PANDA-type fibers each having a core and a pair of stress rods disposed on opposite sides of said core, said two of the optical fiber segments being aligned along the linear cavity with their respective stress rods at a 90-degree rotation angle relative to each other.

In some implementations, at least one of the optical fiber segments of the optical fiber path is configured to avoid crosstalk between said orthogonal principal axes without inducing birefringence.

In some implementations, the first FBG has a first reflectivity profile and the second FBG has a second reflectivity profile detuned from the first reflectivity profile, the linear cavity being configured as a Mamyshev Oscillator.

In some implementations, the first and second FBGs each has a corresponding reflective spectral band, the reflective spectral bands of the FBGs substantially overlapping, thereby defining an overlap spectral range, said light pulse generator further comprising a blocking filter positioned between the FBGs and configured to remove light at wavelengths within a blocking spectral range from the optical path, the blocking spectral range including at least the overlap spectral range.

Other features and aspects of the invention will be better understood upon a reading of embodiments thereof with reference to the appended drawings.

### BRIEF DESCRIPTION OF THE DRAWINGS

FIG. 1 is a schematic representation of a light pulse generator configuration according to one embodiment. FIG. 1A is a 3D view in transparency of two segments of PM optical fiber coupled with a 90-degree junction between them.

FIGS. 2A and 2B show the evolution of a Gaussian pulse being broadened by SPM while propagating in a medium.

FIG. 3 is a cross-sectional schematic view of a PANDA type optical fiber.

FIG. 4A shows an example of a first reflectivity profile the first FBG of the light pulse generator such as shown in FIG. 1. FIGS. 4B and 4C show examples of a second reflectivity profile of the second FBG of the light pulse generator such as shown in FIG. 1.

FIG. 5 is a graph showing the impact of birefringence on the reflectivity profiles of the first and second FBGs.

FIG. 6 is a schematic representation of a light pulse generator configuration according to another embodiment, including a blocking filter in the cavity.

FIG. 7 shows an example of the reflectivity profiles of the first and second FBGs in the configuration of FIG. 6.

FIG. 8 shows an example of the reflectivity profiles of the first and second FBGs and blocking filter in the configuration of FIG. 6.

FIG. 9 is a schematic representation of a monolithic all-PM-fiber ytterbium-doped Mamyshev oscillator gain-managed amplifier laser system using a light pulse generator (linear Mamyshev Oscillator) according to an embodiment.

FIGS. 10A and 10B show the reflectivity profiles of the fiber Bragg gratings of the light pulse generator of the laser system of FIG. 9 on a linear scale (FIG. 10A) and log scale (FIG. 10B), respectively.

FIG. 11A to 11D show measured and computed characteristics, namely the temporal pulse profile (FIG. 11A), the optical spectrum (FIG. 11B), the autocorrelation trace (FIG. 11C), the spectral phase profile (FIG. 11D) for measures, simulated and reconstructed data of light pulses from the light pulse generator of the laser system of FIG. 9, FIG. 11E shows the Radio frequency (RF) spectrum of the measure light pulses and FIG. 11F shows the simulated pulse compressed to the 4^{th} order and transform-limited.

FIGS. 12A and 12B show the simulated pulse spectrum of light pulses within the light pulse generator of FIG. 9 before reaching the LR-FBG (FIG. 12A) and the HR-FBG (FIG. 12B).

FIG. 13A shows the mean pulse wavelength and 2×RMS spectrum width evolution relative to the gain map of light pulses from the light pulse generator of FIG. 9. FIG. 13B shows the pulse energy, peak power, time and spectral width evolution along the whole fiber length in the forward and backward directions.

### DETAILED DESCRIPTION

In accordance with some implementations, there is provided a light pulse generator and a method for generating ultrashort light pulses.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e., the limitations of the measurement system. It is commonly accepted that a 10% precision measure is acceptable and encompasses the term “about”.

In the present description, when a broad range of numerical values is provided, any possible narrower range within the boundary of the broader range is also contemplated. For example, if a broad range value of from 0 to 1000 is provided, any narrower range between 0 and 1000 is also contemplated. If a broad range value of from 0 to 1 is mentioned, any narrower range between 0 and 1, i.e., with decimal value, is also contemplated.

It is to be understood that the phraseology and terminology employed in the present description is not to be construed as limiting and are for descriptive purposes only.

Furthermore, it is to be understood that the technology can be carried out or practiced in various ways and that it can be implemented in embodiments other than the ones outlined described herein.

Meanings of technical and scientific terms used herein are to be commonly understood as by one of ordinary skill in the art to which the invention belongs, unless otherwise defined.

As known to those skilled in the art, ultrashort light pulses have a duration of the order of a few picoseconds (ps) or less. By convention, the duration of a light pulse is typically measured as the full width at half maximum (FWHM) of the peak representing the intensity or irradiance of the light pulse over time. In some implementations, the duration of the ultrashort light pulses may be less than about 10 picoseconds or less then about 1 picosecond. In one embodiment, the duration of the ultrashort light pulses is between about 1 picosecond and about 5 picoseconds. In some implementations, the duration of the ultrashort light pulses may be in the femtosecond (fs) range. Ultrashort light pulses are also referred to in the art as ultrafast light pulses, even if the later expression could technically be said to refer to the speed at which the light pulses travel, which may vary as a function of the refractive index of the medium in which it travels. One skilled in the art will readily understand that in practice, both expressions may be used interchangeably to refer to light pulses of short duration.

The ultrashort light pulses generated by the light pulse generator described herein may be used in a variety of contexts. Examples of applications of ultrashort light pulses include micromachining (e.g., fuel injectors, battery electrodes cutting), ophthalmology, lab-on-a-chip, semiconductor dicing, stents manufacturing, internal engraving of transparent material, etc. Generally, the ultrashort light pulses outputted by the light pulse generator require amplification prior to their use in typical applications. It is well known to amplify ultrashort light pulses using a chirped pulse amplification system. Chirped pulse amplification (CPA) is a widely used technique to amplify light pulses to high energies, while mitigating the deleterious effects of nonlinearities. This is achieved by temporally spreading each pulse before amplification to reduce peak power, followed by post-amplification compression, resulting in a short, high energy pulse train. Other strategies may use a nonlinear amplifier to favor the formation of very short pulses after compression. As examples, the ultrashort light pulses may be amplified using a gain managed systems such as for example described in US20200278498 (WISE) or with a self-similar amplifier scheme [M. Fermann, V. Kruglov, B. Thomsen, J. Dudley and J. Harvey, Physical Review Letters 84, 610 (2000)].

### Light Pulse Generator

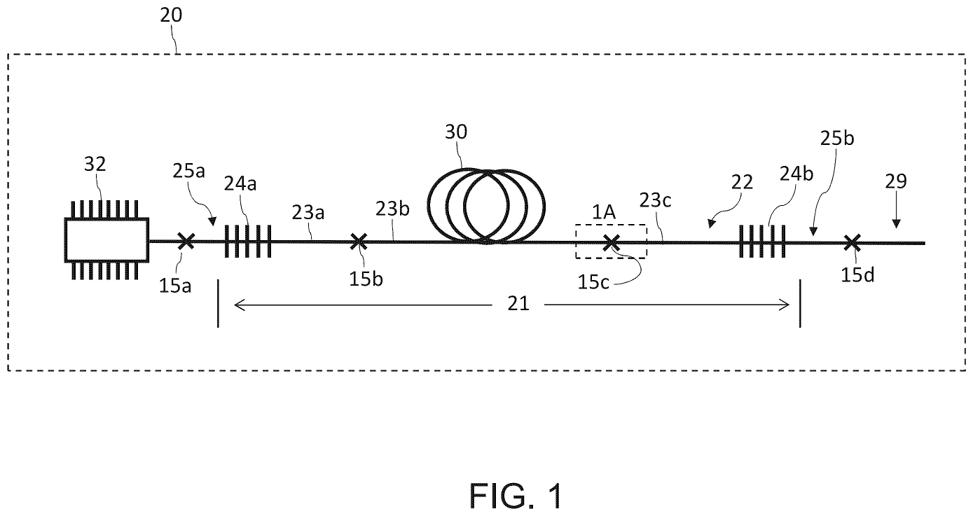

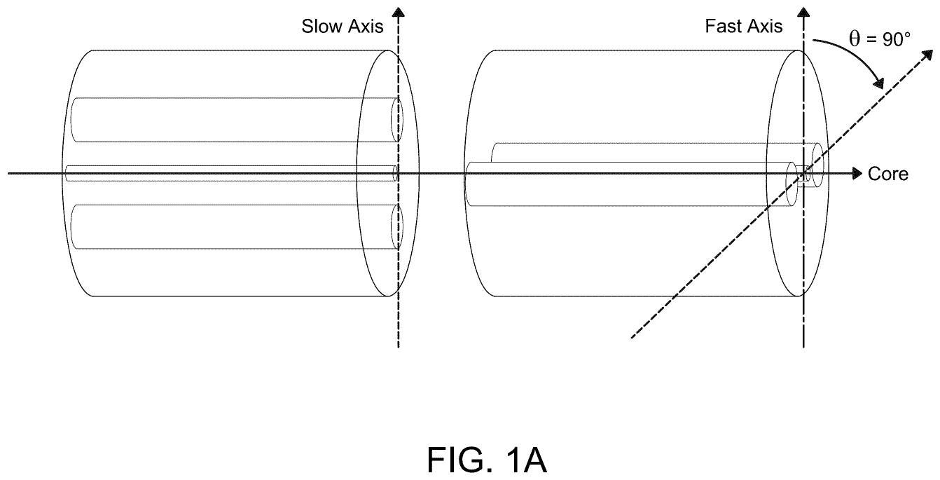

Referring to FIG. 1, a light pulse generator 20 according to one embodiment is schematically illustrated.

Generally, the light pulse generator 20 includes a linear cavity 21 free of polarizing components and configured to generate, based on spectral broadening of light, ultrashort light pulses having a pre-defined polarization. The linear cavity 21 is defined by optical fiber path 22 apt to induce a spectral broadening of light propagating therealong and a pair of Fiber Bragg gratings (FBGs) 24a, 24b disposed at opposite extremities 25a, 25b of the optical fiber path 22. The light pulse generator 20 further includes at least one optical gain region 30 positioned in the optical fiber path 22 between the FBGs 24a, 24b. At least one pump source 32 is coupled to the at least one optical gain region 30. The linear cavity 21 is configured to generate ultrashort light pulses, as will be explained further below.

The optical fiber path 22 is composed of two or more optical fiber segments 23a, 23b, . . . , 23n. The optical fiber path 22 is configured to guide, therealong, polarized light such that a polarization of the guided light is aligned with one of two orthogonal polarization axes. In the illustrated embodiment, three optical fiber segments 23a, 23b and 23c are shown, but it will be understood that other configurations with a different number of optical fiber segments may be envisioned. Further examples are provided below.

Optical fibers are typically composed of a light guiding core and one or more cladding surrounding the core. A protective polymer coating surrounds the outermost cladding. In typical embodiments, the optical fiber segments 23a, 23b, . . . , 23n embodying the optical fiber path 22 are multi-clad, that is, have a plurality of claddings. The optical fiber segments 23a, 23b, . . . , 23n are configured to guide light pulses in a core mode, and optionally guide pump light a cladding mode, as explained further below.

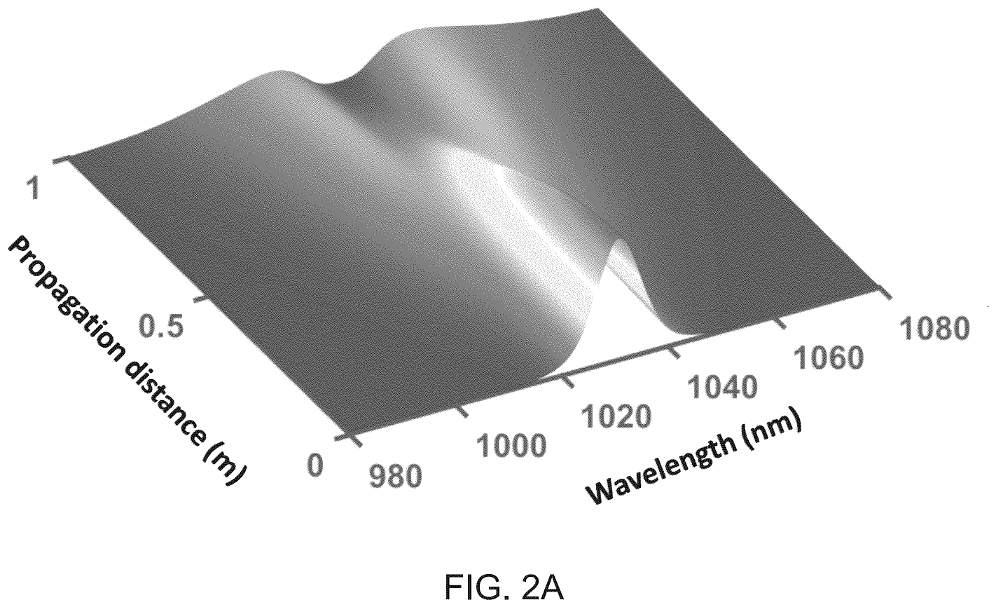

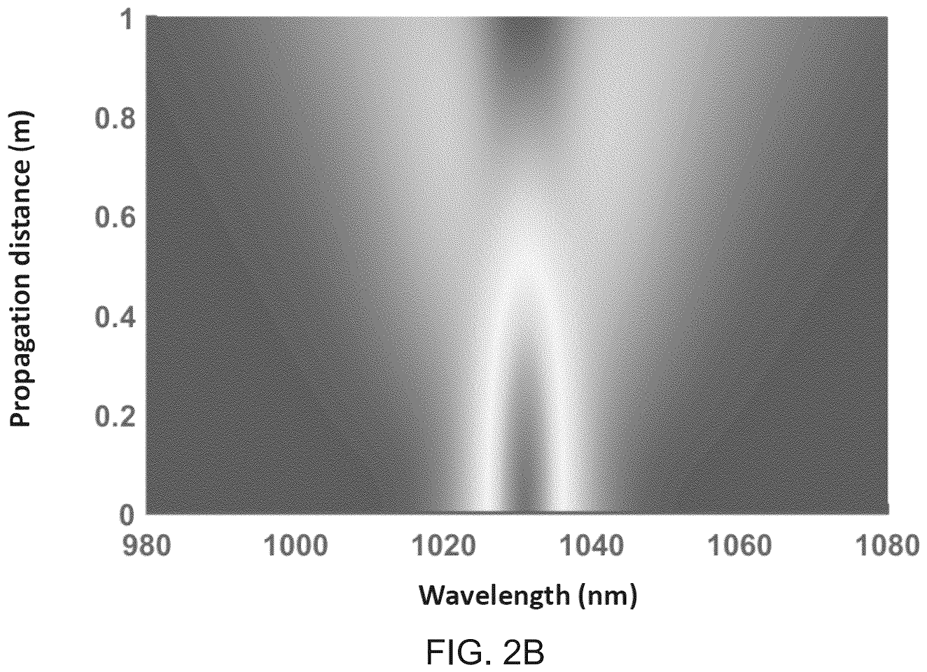

In some implementations, at least one of the optical fiber segments 23a, 23b, . . . , 23n is apt to induce a spectral broadening of polarized light propagating therealong. Spectral broadening refers to the increase of the number of wavelengths, i.e. the increase in the spectral contents of a light pulse as it propagates in medium. In some embodiments, the spectral broadening of the light pulses may be the result of the so-called optical Kerr effect, which refers to circumstances in which the propagation of high intensity light pulses leads to non-linear effects which modify the refractive index of the propagation medium. Different non-linear effects may be the cause of the broadening of the spectrum, such as self-phase modulation, cross-phase modulation, four wave mixing and the like. In some embodiments, the spectral broadening of the light propagating along the optical fiber path generally results from Self-Phase Modulation (SPM). SPM is a nonlinear optical effect whereby the propagation of an ultrashort pulse of light in a medium induces a change in the refractive index of this medium, due to the optical Kerr effect. This variation in refractive index produces a phase shift in the pulse, leading to a change in its spectral profile. By way of example, FIGS. 2A and 2B show the evolution of a Gaussian pulse being broadened by SPM while propagating in a medium.

Each optical fiber segment 23a, 23b, . . . , 23n of the optical fiber path 22 may be of one of a variety of optical fiber types. The core and/or cladding of the optical fiber segment may be made of glass such as silica or any type of oxide glass and may be made of pure glass or may be doped with one or more dopants. The optical fiber segment may or may not be made of a photosensitive material or be photosensitized prior to the writing of a Bragg grating therein, when relevant. As such, co-doping the optical fiber segment with germanium, as is known in the art to enhance photosensitivity, is not necessarily required, although in some embodiments at least some of the optical fiber segment 23a, 23b, . . . 23n may be germanium-doped and hydrogen- or deuterium-loaded to enhanced photosensitivity. In some embodiments, the core and/or cladding of at least some of the optical fiber segment may alternatively be made of a crystalline material such as a sapphire, germanium, zinc selenide, yttrium aluminium garnet (YAG) or other crystalline materials with similar physical properties. In other embodiments, the core and/or cladding of at least some of the optical fiber segment may alternatively be made of low phonon energy glass such as a fluoride, chalcogenide or chalcohalide glass or other glass materials with similar physical properties. The low phonon energy glass medium can be of a variety of compositions, such as, but not limited to, doped or undoped fluoride glasses such as ZBLA, ZBLAN, ZBLALi, chalcogenide glasses such as As₂S₃ or As₂Se₃ or chalcohalide glasses.

The polymer coating of each optical fiber segments 23a, 23b, . . . , 23n, sometimes referred to as the fiber jacket or fiber coating, may be made of any suitable polymer or hybrid polymer material. For example, standard optical fibers for telecommunication or fiber lasers are typically provided with an acrylate or fluoroacrylate-based coating. In other embodiments, the polymer coating may be made of a polyimide, a silicone, a polytetrafluoroethylene (e.g., Teflon™), an organically modified ceramic (e.g., Ormocer™) and the like. In some cases, a thin layer of a hermetic material, such as carbon or metal, can be present at the polymer-to-cladding interface.

Consecutive optical fiber segment 23a, . . . , 23n along the linear cavity 21 may be coupled together by any coupling means maintaining polarization of light. In some implementations, fusion splices 15a, . . . 15m may be provided at each junction as well known in the art.

As mentioned above, the optical fiber path 22 is configured to guide polarized light such that the polarization of this polarized light is aligned with one of two orthogonal polarization axes. As known to those skilled in the art, the phase velocity of light travelling along both major axes of a typical (non-polarization maintaining) optical fiber is nominally the same, in view of the inherent circular geometry of optical fibers. However, in practice, optical fibers typically exhibit a small degree of birefringence, that is, differences in the phase velocity of light travelling in the horizontal and vertical polarization modes, leading to crosstalk between these modes. This effect can be particularly present when the fiber is bent or coiled, creating mechanical stresses-inducing crosstalk. For applications where preserving polarization can be an issue, it is known to use polarization maintaining (PM) fiber, in which linearly polarized light, if properly launched into the optical fiber, maintains a linear polarization during propagation with little or no crosstalk between the two polarization modes. In some implementations, one or more of the optical fiber segments 23a, 23b, . . . , 23n of the optical fiber path 22 are segments of PM optical fiber.

PM optical fibers have a strong built-in birefringence, that is, they are built so that the two orthogonal polarization modes of light propagate along the PM optical fiber at two distinct phase velocities, defining a slow polarization axis and a fast polarization axis. There is typically no coupling of light between the two polarization modes, as the propagation constants of the two polarization modes are significantly different due to the strong birefringence. Provided that the polarization of light launched into the fiber is aligned with one of the polarization axes, this polarization state will generally be preserved even if the fiber is bent.

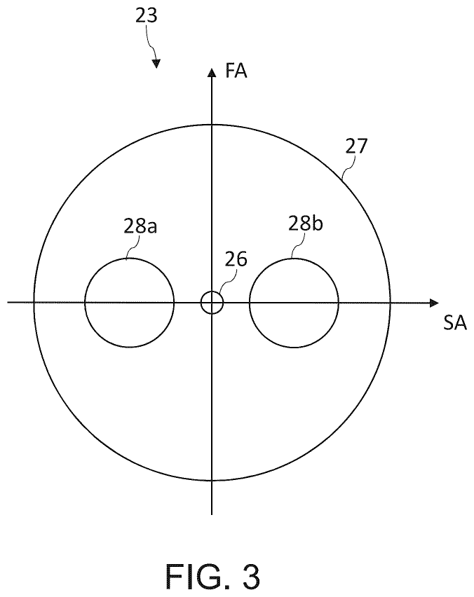

Referring to FIG. 3, in some implementations, the segments of PM fibers 23 are PANDA type optical fibers. As mentioned above, each segment of PM optical fiber 23 includes a core 26 and one or more claddings 27 (only one cladding is shown on FIG. 3, for simplicity). Birefringence is provided by two stress rods 28a, 28b positioned on opposite sides of the core 26, for example within the cladding 27 immediately adjacent to the core 26. The stress rods 28a, 28b have a glass composition differing from the glass compositions of the core 26 and of the cladding 27. The stress rods 28a, 28b are typically introduced in a preform prior to drawing into the PM optical fiber. As well known to those skilled in the art, the stress rods 28a, 28b cause mechanical stress with a well-defined orientation, leading to the desired distinct phase velocities along the so-called fast axis FA and slow axis SA.

As will be readily understood by those skilled in the art, the optical fiber segments 23a, 23b, . . . , 23n may have polarization maintaining configurations differing from PANDA-type optical fibers. In other embodiments, so-called “bow-tie fibers” or elliptical-stress-layer fiber may be used. In another example, photonic crystal fibers (PCF) provided with a proper arrangement of air holes may also provide the required birefringence. In some implementations, the birefringence of an optical fiber segment or part of an optical fiber segment may also be achieved by applying oriented mechanical stress, for example by mechanically compressing the fiber in a direction perpendicular to its length or by some electro-optical effects, resulting in a “flattened” optical fiber. In yet another implementation, a PM segment of optical fiber may be obtained by coiling the segment of optical fiber in such a way as to induce the desired birefringence, while ensuring that polarized light is properly guided along the coiled segment of optical fiber.

In other implementations, one of more of the optical segments 23a, 23b, . . . , 23n may not have a polarization maintaining construction yet be otherwise configured to guide polarized light such that a polarization of the polarized light is aligned with one of two orthogonal polarization axes. The optical fiber path 22 or portions thereof may be configured to avoid crosstalk between polarization modes without inducing birefringence. For example, if the linear cavity is short enough, the optical fiber path 22 may be kept straight, avoiding birefringence-inducing bends. In other implementations, the optical fiber path 22 may be coiled in a careful manner such that mechanical stresses are avoided or minimized.

Referring back to FIG. 1, as mentioned above, the light pulse generator 20 further includes a pair of FBGs 24a and 24b disposed at opposite extremities 25a and 25b of the optical fiber path 22 and at least one optical gain region 30.

Throughout the present description, the expression “Bragg grating” is used to refer to a periodic or aperiodic refractive index pattern induced in a waveguide, the expression “Fiber Bragg grating” or “FBG” being used in the art when the waveguide is an optical fiber. An FBG allows light propagating into the host optical fiber to be reflected in a counterpropagating direction when its wavelength corresponds to the Bragg wavelength of the refractive index pattern, which is related to its period. A chirped fiber Bragg grating has a period, and therefore a Bragg wavelength, which varies as a function of the position along the fiber, defining a reflectivity profile spanning over one or more wavelength bands. The period profile of a chirped Bragg grating is also designated as its dispersion profile, as different wavelengths are reflected at distinct positions along the grating, subjecting them to different delays, therefore creating a chromatic dispersion of the light pulse. The refractive index pattern can be designed to provide a dispersion profile tailored to the desired impact on the characteristics of the reflected light.

At least one of the optical fiber segments 23a, 23c hosting the FBGs 24a, 24b has a birefringence such that orthogonal polarization axes of the fiber define a slow polarization axis and a fast polarization axis. In the illustrated embodiment of FIG. 1, the first and second FBGs 24a and 24b are hosted in first and second FBG-hosting optical fiber segments 23a, 23c which are embodied by segments of PM optical fibers, providing the required birefringence. As explained above, in other variants, flattened segments of optical fiber may be used.

In some implementations, the FBGs 24a and 24b have respective reflectivity profiles selected in view of the desired laser dynamics of the linear cavity 21, as explained further below. As know in the art, one of the FBGs 24a preferably has a high reflectivity tailored to reflect most or the totality of the light at the Bragg wavelength back in the cavity, whereas the other FBG 24b has a lower reflectivity reflecting a first portion of the light at the corresponding Bragg wavelength back in the cavity and allowing a second portion of the light at the Bragg wavelength through towards an output 29.

In some implementations, the optical gain region or regions 30 may be embodied by a length of optical fiber having an active core. As well know in the art, optical amplifications can be enabled by doping the core of an optical fiber with one or more rare-earth ions such as erbium ions (Er3+), ytterbium ions (Yb3+), thulium ions (Tm3+), holmium ions (Ho3+), dysprosium ions (Dy3+), praseodymium ions (Pr3+), neodymium ions (Nd3+) or any combination thereof. In the present description, the rare-earth dopants and/or other dopants may be referred to using the chemical element name of the corresponding oxide. For instance, one can refer to “erbium” or “ytterbium” dopant. One skilled in the art will understand that such elements are present in the optical fiber in their oxide form. Regarding the rare earth dopants, such as ytterbium for instance, one will use the terms “ytterbium”, “Yb³⁺”, “ytterbium oxide”, and “Yb₂O₃” interchangeably.

In some implementations, the rare-earth ions may be embedded in a conventional silica-based matrix. Otherwise, the matrix of the optical fiber can be a low phonons energy glass such as fluoride-, chalcogenide-, chalcohalide-telluride-based glass or the like. For instance, in some embodiments, the low phonon energy glass may be a zirconium fluoride glass having a composition including ZrF such as ZBLAN (ZrF/HfF, BaF₂, LaF₃, NaF, and AlF₃). In some other embodiments, the low phonon energy glass may be an indium fluoride glass having a composition including InF₃. In alternate embodiments, the low phonon energy glass may be an aluminum fluoride glass having a composition including AlF₃. In further embodiments, the low phonon energy glass may be a chalcogenide glass having a composition including As₂S₃, As₂Se₃, AsTe, AsSSe, AsSTe, GaLaS, GeAsS, GeAsSe or the like. Photonic crystal fibers, large mode area (LMA) fiber, and other types of specialty optical fiber may be used as host to the optical gain region 30 without departing from the scope of protection. It will be noted that in other variants, the optical gain region may be configured to provide gain without the need for doping with rare-earth ions. By way of example, in some variants the optical gain region 30 may provide optical gain via nonlinear effects such as stimulated Raman scattering or any other suitable nonlinear effect or combination thereof.

The pump source 32 may be embodied by any light source apt to generate a pump beam which can lead to a population inversion in the associated optical gain region 30. By way of example, the pump source 32 may be embodied by a fibered laser diode optically connected to an optical fiber segment 23 of the optical fiber path 22, for example via fusion splicing or through a WDM coupler provided inside or outside of the linear cavity 21. The pump beam preferably has a spectral profile adapted to the absorption profile of the optical gain region 30. By way of example, an Ytterbium-based optical gain region may be pumped with a pump beam in the 900 nm range (typically 976 nm or 920 nm).

In some implementations, the light pulse generator 22 may be configured to generate ultrashort light pulses based on the presence of two offset filters in a spectrally broadening laser cavity, a configuration known in the art as a “Mamyshev oscillator” (MO).

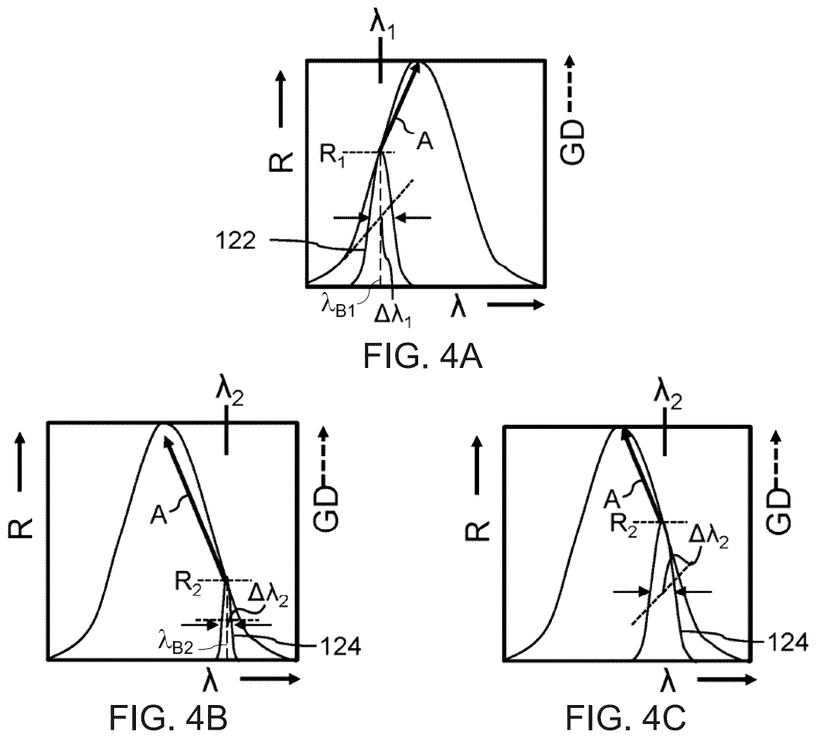

Still referring to FIG. 1, in some embodiments, a first one of the FBGs 24a has a first reflectivity profile which is detuned from a second reflectivity profile of the second one of the FBGs. FIG. 4A shows an example of a first reflectivity profile 122 of the first FBG 24a, which is in this case centered on a first Bragg wavelength λ_{B1}. FIGS. 4B and 4C show examples of a second reflectivity profile 124 of the second FBG 24b, which are in these cases centered on a second Bragg wavelength λ_{B2} being spectrally spaced-apart from the first Bragg wavelength λ_{B1} of the first reflectivity profile 122.

As can be appreciated, the spectral contents of a light pulse reflected by the first reflectivity profile 122 of the first FBG 24a tend to be spectrally broadened (see arrow A) during its propagation in the linear cavity 21 to encompass the second Bragg wavelength λ_{B2} of the second reflectivity profile 124 of the second FBG 24b, and vice versa, thereby allowing light pulses to be reflected in back-and-forth between the first and second FBGs 24a and 24b when the optical gain region 30 is pumped with the pump beam and when the linear cavity 21 is mode locked. As such, only light pulses that are amplified enough to experience spectral broadening as they propagate through the optical gain region 30 can oscillate within the linear cavity 21.

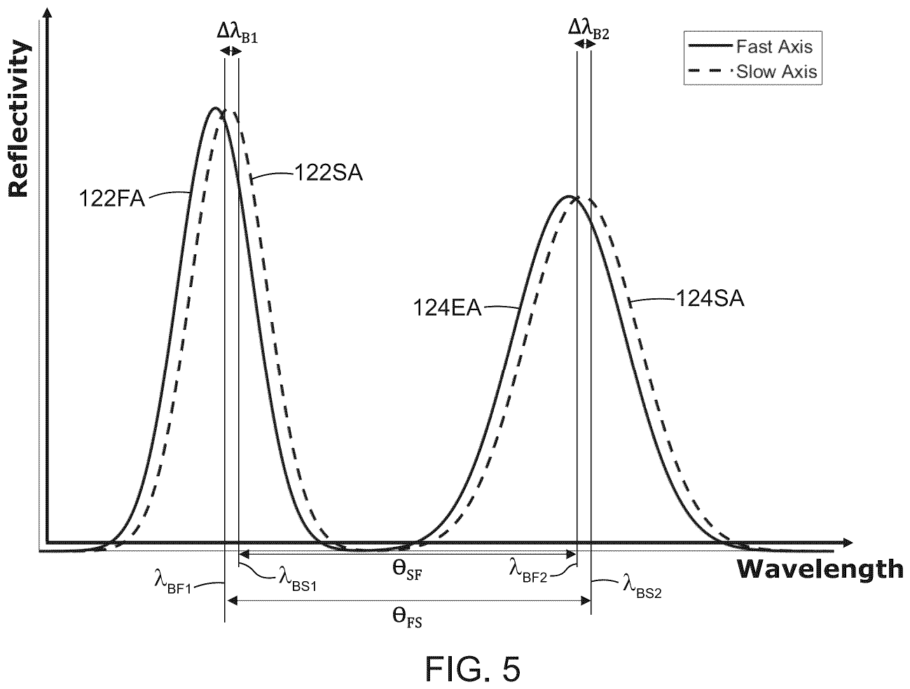

Referring back to FIG. 3 and with additional reference to FIG. 5, the mode guided in the core 26 of a PM optical fiber segment 23 will experience significantly different effective indices of refraction along its two principal axes of polarization, the slow polarization axis SA and the fast polarization axis FA. The process of writing an FBG in PM optical fiber results in two spectrally spaced reflection profiles, since the resonant wavelength of the FBG depends on the effective refractive index of the mode in the optical fiber. The first Bragg grating 24a therefore has a slow axis first reflection profile 122SA centered on a Bragg wavelength λ_{BF1} and a fast axis first reflection profile 122FA centered on a Bragg wavelength λ_{BS1}. Similarly, the second Bragg grating 24b has a slow axis second reflection profile 124SA centered on a Bragg wavelength λ_{BF2} and a fast axis second reflection profile 124FA centered on a Bragg wavelength λ_{BS2}. Light polarized along the fast polarization axis FA (low index) of a PM optical fiber will be reflected at a shorter wavelength than light polarized along the slow polarization axis SA (high index) of the same optical fiber (λ_{BF}<λ_{BS}). The spectral spacing Δλ_{B} between the respective Bragg wavelengths is directly proportional to the difference between the effective indices of the two modes, as well as to the pitch of the FBG.

The use of PM host optical fibers is typically preferred when using FBGs as reflective filters in a spectrally broadened ultrafast laser cavity, such as for example described above, to ensure that the generated light pulses remain linearly polarized and undisturbed by crosstalk. In such an oscillator, the FBGs are spectrally designed to favor a pulsed operation of the laser cavity at the expense of a continuous oscillation. This pulsed operation is typically achieved because of the spectral broadening of the light pulses at high peak power through self-phase modulation. After start-up, such a laser will naturally initiate a pulsed operation in one of the two polarization axes of the PM fiber. In the absence of a polarizing element in the cavity, however, either polarization axis SA or FA may be favored for pulse operation, making it difficult to predict and/or control the polarization and spectral profile of the generated pulses. In addition, the propagation of two pulses aligned with orthogonal axes and competing for gain in the cavity can be detrimental to the start-up of the laser.

In accordance with one aspect, the linear cavity 21 is configured such that light propagating in the optical fiber segment 23a hosting the first FBG 24a with its polarization aligned with one of the two orthogonal polarization axes of the optical fiber path, for example the slow polarization axis SA1, is coupled to the optical fiber segment 23c hosting the second FBG 24b with its polarization aligned with the other orthogonal polarization axis, here the fast polarization axis FA2. Conversely, in this example, the linear cavity 21 is further configured such that light propagating in the segment of PM optical fiber 23a hosting the first FBG 24a with its polarization aligned with the fast polarization axis FA1 is coupled to the segment of PM optical fiber 23c hosting the second FBG 24b with its polarization aligned with the slow polarization axis SA2. Referring again to FIG. 5, it can be observed that the Slow-to-Fast (SF) spectral spacing θ_{SF} between the two FBGs seen by light polarized along the slow axis SA1 of the first FBG 24a and coupled into the second FBG 24b with its polarization aligned with the fast polarization axis FA2 is shorter than the Fast-to-Slow (FS) spectral spacing θ_{FS} seen by the orthogonally polarized light. It has been found by the inventors that this leads to a strong favoring of the propagation of the light seeing the shorter spacing back and forth within the cavity, leading to the generation of light pulses with the corresponding polarization and spectral contents. Indeed, the polarized light propagating back and forth within the cavity will experience less loss when aligned with the polarization axis exhibiting the shortest spectral spacing, thus favoring a systematic start-up in this polarization axis, resulting in a predetermined single axis polarization pulse generation. In some implementations, the required spectral spacing may be provided by the birefringence induced in the optical fiber hosting one of the FBGs only. Such a cross-polarization configuration therefore takes advantage of the birefringence of FBGs in PM optical fiber to ensure a systematic start-up in only one predetermined polarization axis, without the necessity to add a polarizer or other polarizing component in the cavity.

In a linear cavity 21 such as the one illustrated in FIG. 1, the initial unpolarized light generated by the gain medium 30 may have just enough spectral width to flow predominantly in the favored polarization axes. The light becomes linearly polarized after a few passes in the cavity. It then becomes spectrally wider and wider as it gains energy. In its final state, the generated light pulse is spectrally broad enough to cover the Bragg wavelengths of both spectral profiles 122FA, 122SA and 124FA, 124SA of both FBGs, but it is no longer able to be coupled in the other polarization axis due to the properties of the PM fiber. In typical implementations, start-up is preferably assisted by pump modulation to generate a disturbance that initiates the interaction between the filters.

It has been found by the inventors that the present configuration can systematically lead to the desired favoring of a same polarization state, even if the difference between the SF spectral spacing θ_{SF} and the FS spectral spacing θ_{FS} is quite small compared to spectral width and spacing of the FBGs. In one example of implementation, a difference in spectral spacing θ_{SF}−θ_{FS} was of the order of 0.6 nm while the spectral width of the FBGs themselves was of the order of several nm.

Referring to FIGS. 1 and 1A, in some implementations, the crossing of the polarization axes may be achieved by coupling two of the segments of PM optical fiber 23a,23b or 23b,23c of the linear cavity 21 together with a 90-degree junction between them. The slow polarization axis SA1 and the fast polarization axis FA1 of the segment of PM optical fiber 23a hosting the first FBG 24a are therefore respectively aligned with the fast polarization axis FA2 and the slow polarization axis SA2 of the segment of PM optical fiber 23c hosting the second FBG 24b. By way of example, two consecutive segments 23b, 23c of PANDA-type PM optical fiber within the linear cavity may be coupled together with their stress rods 28a, 28b aligned at a 90-degree rotation angle relative to each other. Similarly, the desired cross polarization may be achieved in bow-tie fibers, elliptical-stress-layer fibers or photonic crystal fibers (PCF) by coupling two optical fiber segments together with their respective slow and fast polarization axis crossed. The two consecutive segments of PM fiber 23a,23b or 23b, 23c may be coupled together through fusion splicing or other means, in as much as such coupling means conserve light polarization. For example, a fiber coupler coupling light between the two fiber segment extremities through resonance can be used. In other implementations, the respective slow and fast polarization axis of the fibers hosting the FBGs may have a same orientation, but the polarization of the light circulating along the optical fiber path may be rotated along the way. For example, a half waveplate may be introduced in the optical fiber path to rotate the light polarization by 90-degrees. In such an example the optical fiber path may be interrupted, and the light coupled out of the path and back in through lenses, the half waveplate being inserted between these lenses.

It will be readily understood that the 90-degree junction mentioned above may be provided at any one of the fusion splices 15a, 15b or 15c within the linear cavity 21, this is, at any point between the first and second FBGs 24a, 24b. The remaining fusion splices preferably couple the corresponding slow or fast polarization axis of the connected segments of PM optical fiber together. In some variants, more than one 90-degree junctions may be provided, preferably in an odd number so that the resulting effect is to cross the polarization axes at the two FBGs.

In other implementations, the cross-polarization approach described above may be used for light pulse generators such as described in co-pending application U.S. 63/481,897 filed on Jan. 27, 2023, the entire contents of which are incorporated herein by reference.

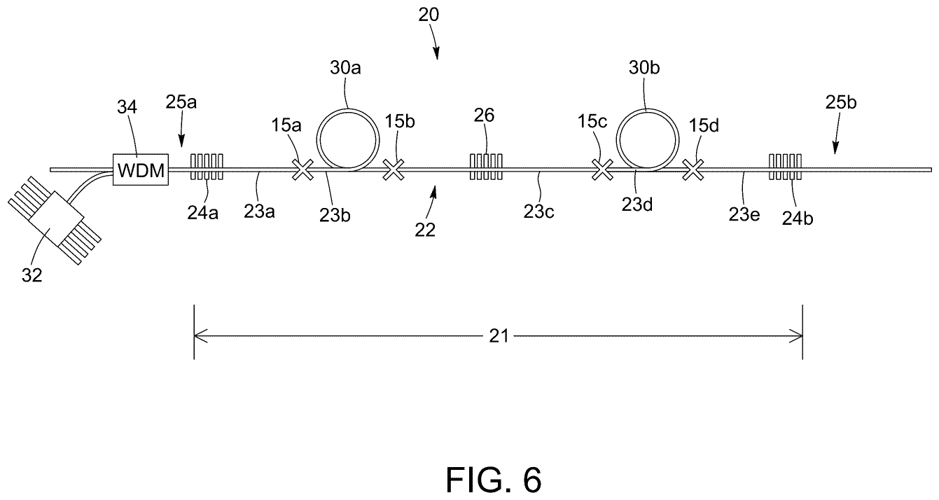

Referring to FIG. 6, there is shown an example of such a light pulse generator 20 including a linear cavity 21 configured to generate ultrashort light pulses, including an optical fiber path 22 apt to induce a spectral broadening of light propagating therealong, the optical fiber path 22 being composed of a plurality of segments of Polarization Maintaining (PM) optical fibers 23a, . . . 23e. Each segment of PM optical fiber 23 has a slow polarization axis and a fast polarization axis, as explained above. The linear cavity 21 further includes first and second FBGs 24a, 24b disposed at opposite extremities of the optical fiber path 22 and each hosted in a corresponding one 23a, 23e of the segments of PM optical fiber. The slow polarization axis and the fast polarization axis of the segment of PM optical fiber 23a hosting the first FBG 24a are respectively aligned with the fast polarization axis and the slow polarization axis of the segment of PM optical fiber 23e hosting the second FBG 24b. The linear cavity 21 is configured such that light propagating in the segment of PM optical fiber 23a hosting the first FBG 24a with its polarization aligned with the slow polarization axis is coupled to the segment of PM optical fiber 23e hosting the second FBG 24b with its polarization aligned with the fast polarization axis, and vice versa, as explained above. By way of example, any two consecutive segments of PANDA-type PM optical fiber within the linear cavity 21 may be spliced together with their stress rods aligned at a 90-degree rotation angle relative to each other.

Two optical gain regions 30a, 30b are positioned in the optical fiber path 22 between the FBGs 24a, 24b. In the illustrated embodiment, a single pump source 32 is used to pump both optical gain regions 30a, 30b and is coupled to one of the extremities 25a of the optical fiber path using a WDM coupler 34. Preferably, the pump source is configured to inject a pump beam in a core mode of the optical fiber or fibers embodying the optical fiber path 22. In the illustrated embodiment the pump beam is adapted to pump said pair of optical gain regions along the optical fiber path. Other gain region and pump configurations may be used without departing from the scope of protection.

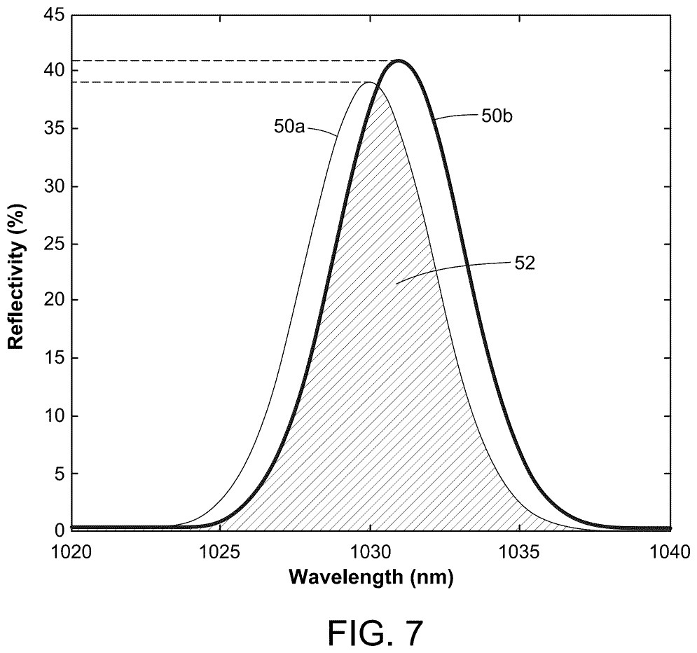

With additional reference to FIG. 7, in such a configuration, each FBG 24a, 24b has a refractive index pattern designed to provide a corresponding reflective spectral band 50a, 50b. In some embodiments, the reflective spectral bands 50a, 50b, substantially overlap, thereby defining an overlap spectral range 52. In some implementations, the two FBGs 24a and 24b have identical or nearly identical reflectivity profiles, that is, their corresponding reflective spectral bands 50a, 50b completely or almost completely overlap, for example overlapping over about 90% or more of the reflective spectral bands of the FBGs. The shapes and reflectivity levels of the reflective spectral bands 50a, 50b of the two FBGs may be identical or different.

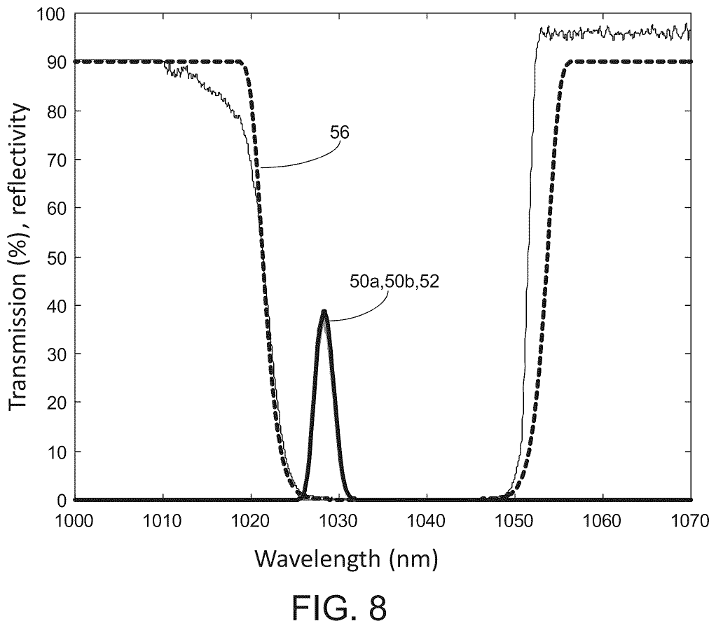

The light pulse generator 20 of this embodiment further includes a blocking filter positioned along the optical fiber path 22 between the two FBGs 24a, 24b. The blocking filter 26 is configured to remove light at wavelengths within a blocking spectral range 56 (see FIG. 8) from the optical fiber path. Wavelengths within the blocking spectral range 56 are therefore not reflected in a counterpropagating direction in the core, but instead directed outside of the core of the segment of PM optical fiber 23c hosting the blocking filter 26. The blocking spectral range includes at least the overlap spectral range, as will be explained further below. In some implementations, the blocking spectral range 56 is composed of the overlap spectral range 52 of the FBGs 24a, 24b, and wavelengths immediately above the overlap spectral range 52. In other variants, the blocking spectral range 56 is composed of the overlap spectral range 52 of the FBGs 24a, 24b, and wavelengths immediately below the overlap spectral range 52. It will be noted that in some variants the overlap spectral range may not coincide with an end portion of the blocking spectral range and may be at another location within the blocking spectral range, inasmuch as the light pulse generator is configured to provide sufficient spectral broadening of light to enable its operation as will be described further below. In some implementations, the blocking filter 26 may be a slanted FBG provided in the core of the host fiber. In variants, the blocking filter 26 may be embodied by a long period grating (LPG).

The process of generating ultrashort light pulses using the light pulse generator according to the embodiment of FIG. 6 is explained below. Further details and explanations can be found in U.S. 63/481,897. In this example, both spectrally FBGs 24a, 24b are assumed to have reflectivity bands which completely overlapped and the blocking spectral range 56 of the blocking filter includes the overlap spectral range and beyond.

The process begins with the circulation of a seed laser pulse along the optical fiber path 22. Preferably, the light pulse generator includes a starting mechanism apt to launch the seed light pulse along a core mode of the optical fiber path. The seed laser pulse has an initial spectral profile which depends on the nature and operation of the starting mechanism. The initial spectral profile preferably includes wavelengths within the blocking spectral range. As the seed light pulse propagates along the optical fiber path 22, it is reflected back and forth between the first and second FBGs 24a, 24b, the travelling light pulse defining a cavity pulse of growing intensity and varying spectral contents.

Initially, the cavity pulse propagates in a first direction, which is towards the right in the illustrated embodiment, along the optical fiber path 22 on the left side of the cavity and through the first optical gain region 30a, gaining intensity from the optical gain region. As this propagation occurs, the spectrum of the cavity pulse is broadened. The broadened spectral profile of the cavity pulse may include wavelengths shorter and longer than the wavelengths of the initial spectral profile, some of which extending beyond the blocking spectral range. Upon reaching the blocking filter 26, the spectral components of the cavity pulse within the blocking spectral range are extracted from the optical fiber path 22, leaving only the wavelengths outside of the blocking range 56. As the cavity pulse continue propagating towards the right along the optical fiber path 22 in the right side of the cavity, it is amplified by the second optical gain region 30b, and spectrally broadened to again extend to shorter and higher wavelengths than those allowed through by the blocking filter 26, now including higher wavelengths extending within the blocking spectral range 56 and the overlap spectral band 52. Upon reaching the second FBG 24b, only the wavelengths within the corresponding reflective spectral band 50b are reflected, transmitting all other wavelengths through to the second output. In some implementations, light at the transmitted wavelengths may define an output pulse having an output spectral profile having output wavelengths. In the illustrated example, the output wavelengths mainly include wavelengths immediately adjacent the reflective spectral band 50b of the second FBG 24b on the blue (shorter) side, as well as lower intensity light peaks at wavelengths on the red (longer) side.

The reflected cavity pulse, now having a spectral profile corresponding to the reflectivity band 50b of the second FBG 24b, then makes another pass along the optical fiber path 22, this time travelling in a second direction opposite the first direction, towards the left in the illustrated embodiment. As it propagates along the right side of the cavity and through the second optical gain region 30b, the cavity pulse is again amplified and spectrally broadened. Upon reaching the blocking filter 26, all wavelengths within the blocking spectral range 56 are extracted from the optical fiber path 22, again leaving only the wavelengths outside of the blocking range in the cavity pulse. The cavity pulse then propagates along the left side of the optical fiber path 22, towards the left, and is spectrally broadened and amplified by the first optical gain region 30a. Upon reaching the first FBG 24a, the spectral portion of the cavity pulse outside of the reflective spectral band 50a of the first FBG 24a are transmitted through, and optionally define output pulses at output wavelengths. Again, in the illustrated embodiment the output pulse mainly include wavelength immediately adjacent the reflective spectral band 50a of the FBG 24a on the blue (shorter) side. The spectral portion of the cavity pulse within the reflective spectral band 50b of the first FBG 24a is reflected back along the cavity 21, and the cycle begins again.

As explained above, the crossing of the polarization axes within the cavity will lead to a favoring of light aligned with one of the pairs of coupled polarization axes, ensuring that the light pulses generated will be systematically polarized along the favored direction. In the illustrated example, the spectral range of filter 24a in its slow polarization axis significantly overlap the spectral range of filter 24b in its fast polarization axis (or the opposite), such as when the polarization axes are crossed between both filters, a single polarization is favored.

### Example of Implementation

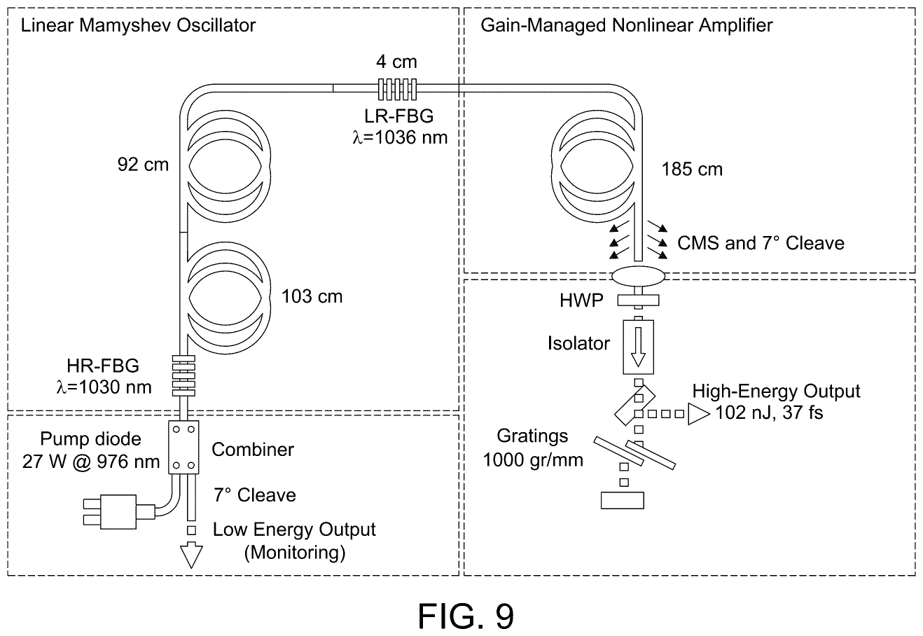

Referring to FIGS. 9 to 15, an example of implementation a light pulse generator as defined herein used in a CPA system is presented. This example provided for illustrative purposes only and is not considered limitative to the scope of protection.

Referring to FIG. 9, a monolithic all-PM-fiber ytterbium-doped Mamyshev oscillator gain-managed amplifier (MOGMA) laser system is shown. The linear cavity oscillator is terminated by fiber Bragg gratings. The fiber amplifier is spliced directly on the oscillator and they both share the pump power emitted by a single diode. The oscillator is designed to ensure self-starting through pump modulation, while avoiding SBS-induced damage. Its short length allows for reduced energy and spectral broadening within the oscillator and favours single-pulse operation. The amplifier is designed to bring the pulses to a high energy and duration below 40 fs by taking advantage of the GMN pulse evolution. This efficient, compact and single-unit fiber laser source generates pulses centered at 1060 nm with a repetition rate of 52 MHZ, an energy of 102 nJ, a FWHM duration of 37 fs and a peak power over 2 MW after compression by a pair of gratings. The absence of thermally sensitive components and the purely core-guided signal throughout the laser paves the way for energy/peak power/average power scaling in larger mode area fibers.

In this example, the pump laser diode (BWT, K976AAHRN) can provide up to 27 W and is stabilized at 976 nm to maximize absorption. The Mamyshev oscillator has a linear configuration terminated by low- and high-reflectivity fiber Bragg gratings at 1036 nm and 1030 nm, respectively. The oscillator is followed by the GMN amplifier which is spliced directly on the LR-FBG and terminated by a cladding mode stripper to eliminate the residual pump power. The output yields chirped high-energy picosecond pulses. A standard pulse compressor based on a pair of high-quality transmission gratings (II-VI LightSmyth™ 1040 nm, 1000 grooves/mm, 85% overall efficiency) is then used to compress the pulses in the femtosecond regime to achieve high peak power. The whole fiber length is made of 10 μm core double-clad polarization maintaining fibers. The length of the gain fiber within the oscillator (LY) was chosen to enable a self-starting operation while keeping as much pump power as possible for the amplifier. The length of the passive fiber near the HR-FBG was adjusted to obtain a repetition rate near 50 MHz. The passive fiber length between the oscillator and the amplifier was minimized to reduce dispersion and nonlinear perturbations in the GMN amplifier pulse evolution. Ideally, the LR-FBG is preferably inscribed directly within the gain fiber to avoid those perturbations. As discussed below, the amplifier length (LA) was chosen to optimize the gain-managed nonlinear amplification and allow efficient compression of the high-energy pulses to femtosecond duration. Angled cleaves at both fiber outputs are provided to avoid parasitic CW lasing within the laser system. The low reflectivity of the LR-FBG is required to maintain the pulse compressibility after the amplifier. Since the pulse incident on this FBG is linearly chirped, a stronger spectral filtering at this position would result in a temporal splitting of the pulse. The weakened feedback still allows for enough spectral broadening to overlap the HR-FBG in the opposite direction due to the long passive fiber segment and high spectral energy density of the incoming pulse.

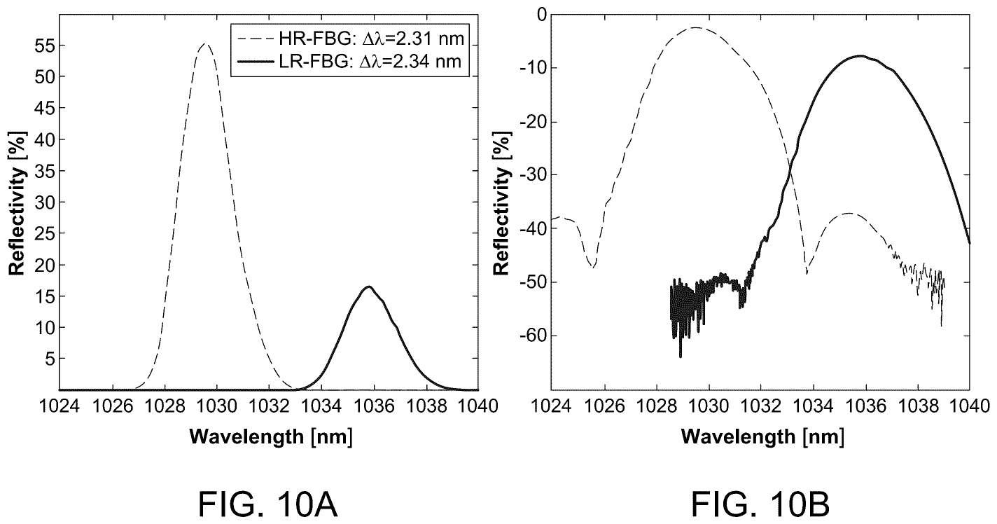

The reflectivity profiles of the fiber Bragg gratings are shown in FIG. 10. The combination of large bandwidth (>2 nm) and good reflectivity (20-60%) was achieved by inscribing a very short grating length (about 120 μm FWHM Gaussian apodization) with high index modulation (Δn up to 2.5×10−3). To fulfill all those requirements in a large mode area, low-NA and thus low-photosensitivity fiber, a proprietary inscription method from TeraXion based on the phase-mask femtosecond inscription technique was used. The bandwidth of the FBG was limited by how short gratings could be produced with a smooth Gaussian reflectivity profile. Mode-locking of the oscillator is achieved by pump modulation with a 100 kHz square wave at 25% duty cycle and 20 W peak-to-peak amplitude. a pump driver (MESSTEC, FM 20-06) with a fast rise time of 50 ns was used. The 100 kHz frequency is a reliable but not critical value since mode-locking was observed with modulation frequencies ranging from 70 to 350 KHz. In the inventors' experience, keeping the average power as low as possible with a sharp modulation amplitude leads to reliable single-pulse mode-locking while avoiding damage to the fibers. The use of a lower duty cycle is thus beneficial. It is possible to obtain mode-locking without pump modulation by using an extremely high pump power (20 W) and a smaller filter offset (˜5 nm). The laser then starts in a higher harmonic order such as n≥10 with a repetition rate higher than 500 MHZ. Single-pulse operation is obtained from there by lowering the pump but a significant filter overlap CW does breakthrough. A shorter cavity with more pump power could probably result in a reliable high-energy GHz oscillator-amplifier laser source.

Due to the MO properties, the laser always starts in a linearly polarized state along a single axis of the PM-fiber. Furthermore, the high birefringence (3×10⁻⁴) of the fiber implies a center wavelength shift of about 0.3 nm for each FBG between the slow and fast axes. To take advantage of this, the HR-FBG and the gain fiber were spliced together with their panda rods aligned at a 90° rotation angle relative to each other. This causes a 0.6 nm spectral filter offset difference between the two linearly polarized states of the cavity (HR-slow/LR-fast vs HR-fast/LR-slow). This difference results in a polarization-dependent loss which is significant enough to always self-start in the favoured polarization state without any polarizer in the cavity. Otherwise, the odds of starting in a given polarization state would be near 50/50. Over one hundred tests with these settings, the inventors found a start rate of 100% for single-pulse near-instantaneous mode-locking in the chosen polarization state. Once mode-locking is achieved, the pump modulation is stopped and the average pump power is increased up to 15 W for optimal performance.

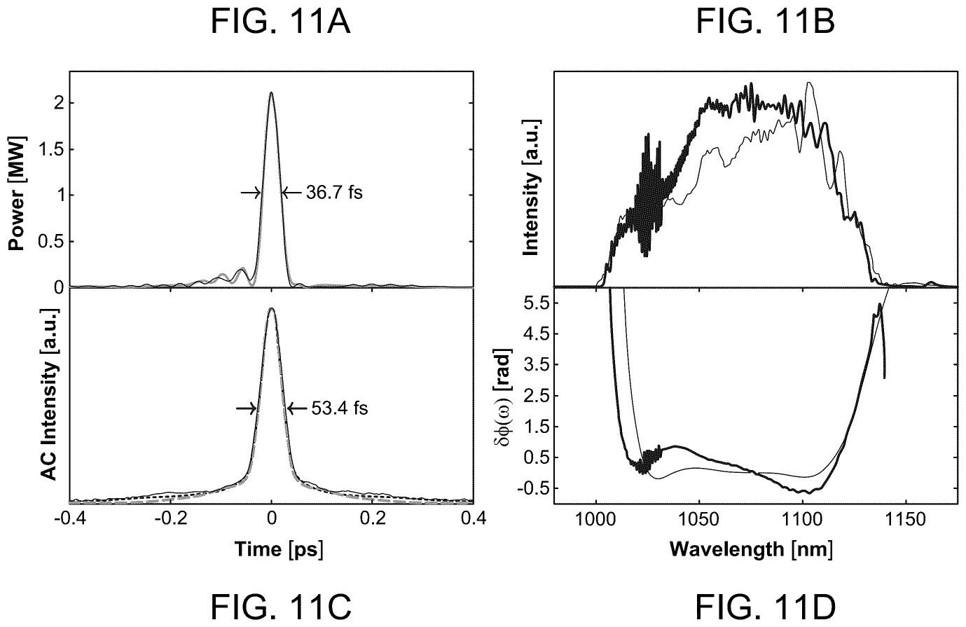

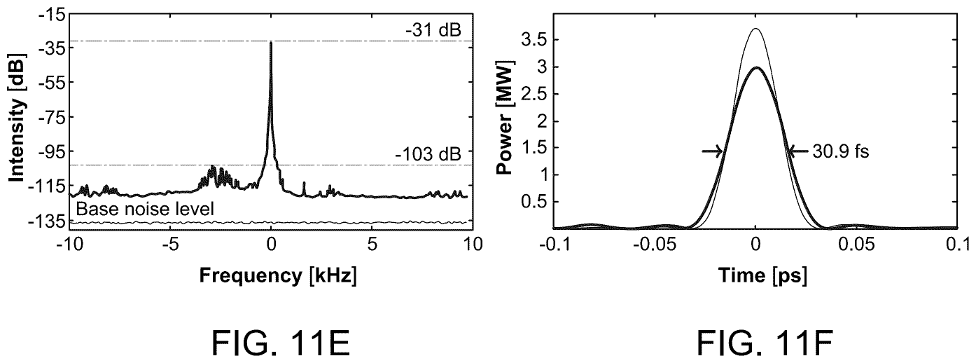

Measured and computed characteristics of the pulse are shown in FIG. 11A to 11F. Before the isolator (T=93%), this MOGMA laser yields 129 nJ and 2 ps pulses at a repetition rate of 52 MHz for an average signal power of 6.71 W and optical laser efficiency of 45%. After the passage in the grating pair, an intensity auto-correlation trace reveals a pulse FWHM duration of 36.7 fs. The remaining average power is 5.30 W, for a pulse energy of 102 nJ. The spectrum reveals a spectral shoulder between 1140 and 1200 nm associated with stimulated Raman scattering (SRS). The simulations are in excellent agreement with the experimental results and they confirmed this point. The Raman energy fraction is computed to be only 0.6% of the total pulse energy. For an accurate estimation of the peak power taking into account the energy lost in the side lobes, a numerical reconstruction of the pulse is done with the PICASO algorithm. A peak power of 2.13 MW was found with 78% of the energy in the central lobe. The compressed pulse spectral phase profile shows a lack of β4 compensation from the transform-limited pulse. From the simulation, a phase correction up to the 4th order yields a near transform-limited pulse of 31 fs and 3 MW peak power. Of course, a more complex compressor might also induce more losses and would not necessarily be advantageous. The radio frequency spectrum (resolution bandwidth of 50 Hz), shows a good signal to noise ratio of 72 dB despite the high round-trip gain and nonlinear phase in the system.

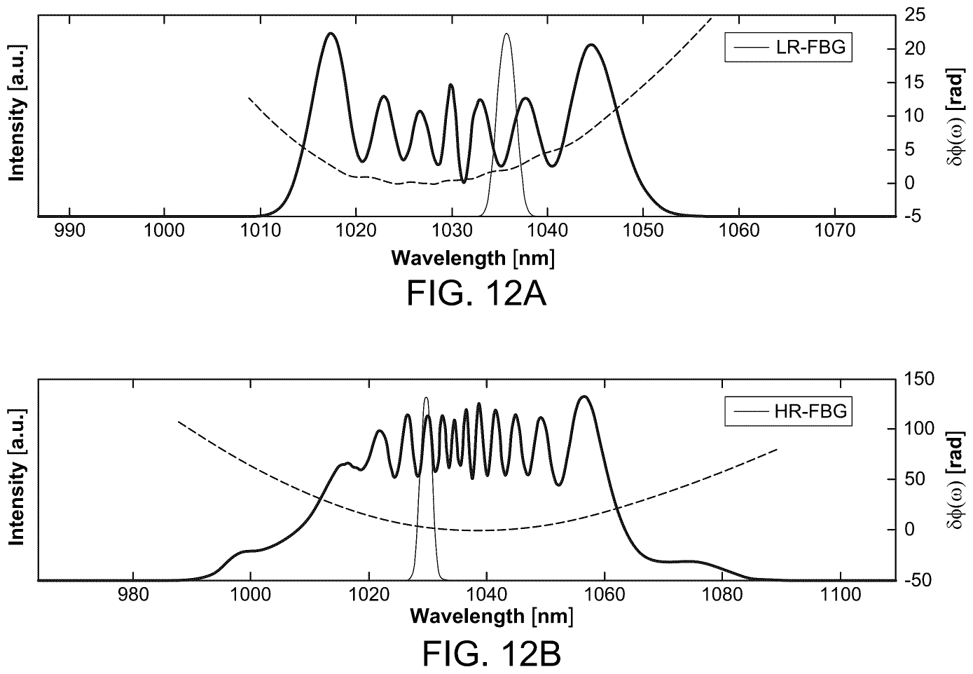

The numerical model is based on the well-known generalized nonlinear Schrödinger equation and accounts for dispersion up to the 4th order, self-phase modulation (SPM), Raman scattering and self-steepening. The wavelength-dependent gain is computed from the ytterbium absorption and emission cross sections with the population equations solved in the steady state. The simulations allow to analyze the intra-fiber pulse dynamics and highlight a path for improvements. Within the oscillator, the short cavity length, narrow filters and high gain yield a pulse evolution heavily dominated by nonlinearity. The parabolic attractor does not have enough propagation distance to fully smooth the spectrum. As a result, the pulse reaching the LR-FBG exhibits strong spectral modulations as can be seen in FIGS. 12A and 12B, typical of SPM with moderate dispersion. In the other direction, the pulse has a high energy in the passive fiber and aggregates a much larger nonlinear phase. In that direction, dispersion plays a greater role which helps reduce the depth of spectral modulations and maintain temporal stability. The oscillator is stable for a pump power of 2 to 6 W and 8 to 18 W. Above 18 W, the oscillator is unstable due to excessive spectral broadening and high losses. Between 6 and 8 W, the oscillator exhibits an instability zone where the pulse cannot reach steady state. This behaviour was expected and previously studied by Želudevičius et al. for an MO dominated by SPM (see Želudevičius et al., Opt. Express. 26, 27247 (2018)). This is the case here at low gain where the pulse does not spectrally broaden fast enough for dispersion to be influential in both directions. In the unstable pump region, the pulse spectral lobes never coincide with the filter windows to prevent fission. At pump level near threshold (2 to 6 W), the LR-FBG filter stays within the first spectral lobe and a stable state is again observed.

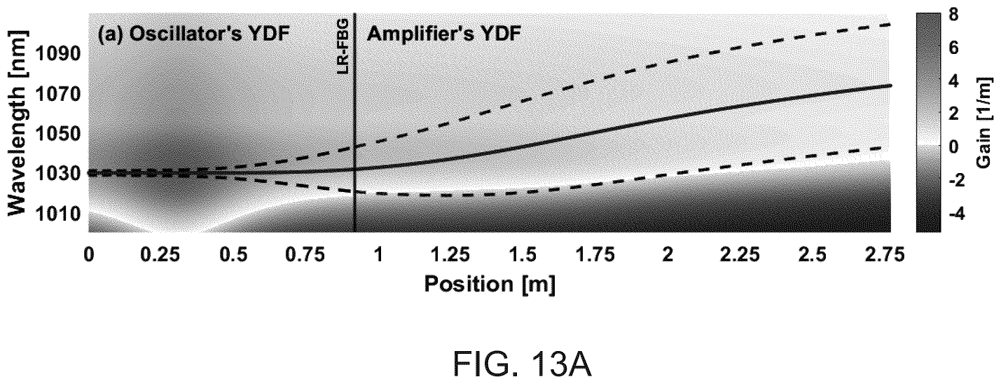

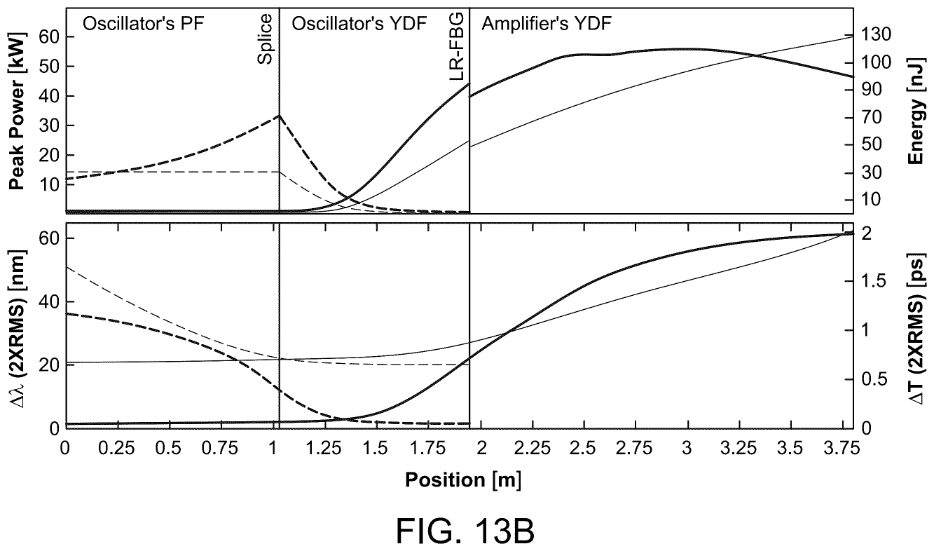

As can be seen in FIGS. 13A and 13B, the pulse clearly exhibits a GMN evolution within the oscillator-amplifier as it co-propagates with the pump, starting from the 0.7 nJ and 0.7 ps gaussian pulse reflected by the HR-FBG. Notably, as the spectrum of the pulse broadens, its shorter wavelengths undergo absorption which induces an asymmetric spectral broadening with a significant shift of the mean spectrum towards longer wavelengths. As the absorption becomes critical, the pulse deviates from the parabolic pulse attractor and a saturation of the spectral broadening and peak power is observed while the pulse energy and duration keep growing. Those effects help to slow down the onset of SRS and wave-breaking. By proper management of the amplifier length, input pulse wavelength, energy, duration and pump power, a very high output pulse energy with very short duration after compression can be achieved. Previous implementations of the GMN regime using similar gain fiber parameters (10 μm core diameter and cladding absorption of 6.4 dB/m @975 nm) reported a pulse energy between 80 and 190 nJ with pulse duration ranging from 33 to 40 fs. Here, similar performances were obtained despite the oscillator integration causing dependencies between seed energy and pump power. For the GMN amplifier, energy scaling above 1 pJ level in a 30 pm-core fiber was reported. Accordingly, the present MOGMA laser is expected to follow a similar trend in terms of energy scaling.

With this laser system as with the previous studies mentioned above, one limitation is SRS. When the inventors tried to pump harder or use a longer amplifier to get an energy above 130 nJ, SRS starts to transfer a critical portion of the pulse energy in the Raman shoulder and pulse compressibility is lost. To observe a similar SRS intensity in the simulations, it is necessary to add an amplifier input noise of 2.3 μW/GHz (or 2.7×105 photons/GHz @1150 nm per round-trip period). Regarding this high noise figure, it should be noted that the Raman response still lies within the ytterbium's gain cross section where some ASE is expected. The latter feeds and dramatically accelerates the exponential growth of Raman at 1150 nm. However, it is feasible to imagine a strategy to reduce the emission or filter out this noise, most of which is coming from the oscillator's highly inverted ytterbium ion population. With simulations, a MOGMA was optimized for a low-noise scenario at a similar repetition rate of 50 MHz (pump power=25 W, LP=1.55 m, LY=0.50 m, LA=3.0 m). Without accounting for free-space propagation losses, a 25 fs pulse of 300 nJ and up to 9 MW peak power is achievable if the noise spectral density is kept below 0.1 μW/GHz @ 1150 nm in this configuration.

To summarize, a new MOGMA laser architecture was developed, where an SPM-dominant, pulse energy and spectral width restrained MO is combined with a GMN amplifier to achieve high energy (>100 nJ) and very short (<40 fs) pulse generation. Furthermore, we have shown that it can be implemented in a cost-efficient single-pump all-PM-fiber configuration with FBGs as filters. In this specific demonstration, femtosecond inscribed low-dispersion FBGs were used, allowing for a shorter cavity length and a high repetition rate of 52 MHz. the inventors also got rid of the need for an intra-cavity polarizer to select the polarization state by taking advantage of the FBG polarization-dependent resonance wavelength within a PM fiber. The result is a purely core-guided fiber laser compatible with a very high average power. Those features are of great interest for many power-hungry applications such as video-rate multi-photon microscopy, micro-machining, texturing and 3D printing. In addition, the inventors anticipate further power scaling based on the use of larger mode area fibers. An all-fiber MOGMA laser yielding 100 W average power and >1 μJ sub-40 fs pulse generation might be envisioned. Such a powerful source could easily be combined with nonlinear fibers or crystals to generate multi-watt power laser light at various wavelengths.

Advantageously the MOGMA laser as described above, and other variants thereof, can be tailored for specific applications at lower or higher repetition rates or energies. Of course, the GMN amplifier approach is restrained by the nonlinear intensive pulse evolution process inducing many dependencies between pulse energy, time duration and spectral width. For a very high spectral energy density, a chirped-pulse amplification system (CPA) may be the favoured method. However, the MOGMA architecture is expected to provide a custom super-robust, compact and low-cost femtosecond solution for a wide range of parameters and applications.

Of course, numerous modifications could be made to the embodiments described above without departing from the scope of the claims.

1. A light pulse generator, comprising:
a linear cavity free of polarizing components and configured to generate, based on spectral broadening of light, ultrashort light pulses having a pre-defined polarization, comprising:
an optical fiber path comprising a plurality of consecutive optical fiber segments each configured to guide polarized light such that the polarization of the polarized light is aligned with one of two orthogonal principal axes;
first and second Fiber Bragg gratings (FBGs) disposed at opposite extremities of the optical fiber path and respectively hosted in a first and a second FBG-hosting optical fiber segment from said plurality of optical fiber segments, the first and second FBG-hosting optical fiber segments each having a birefringence defining a slow polarization axis and a fast polarization axis as said orthogonal principal axes; and
at least one optical gain region positioned in the optical fiber path between the FBGs;
wherein the linear cavity is configured such that the slow polarization axis of the first FBG-hosting optical fiber segment is aligned with the fast polarization axis of the second FBG-hosting optical fiber segment.

2. The light pulse generator according to claim 1, wherein two or more of the optical fiber segments of the optical fiber path are segments of polarization maintaining optical fibers.

3. The light pulse generator according to claim 2, wherein said segments of polarization maintaining optical fibers are PANDA-type fibers, bow-tie fibers, photonic crystal fibers having a birefringence-inducing arrangement of air holes, flattened optical fibers or coiled optical fibers with a birefringence-inducing coiling or combinations thereof.

4. The light pulse generator according to claim 2, wherein two consecutive ones of said segments of polarization maintaining optical fibers are coupled together with a 90-degree junction between their respective principal axes.

5. The light pulse generator according to claim 4, wherein said 90-degree junction is a fusion splice.

6. The light pulse generators according to claim 4, wherein said two consecutive ones of the optical fiber segments coupled together with a 90-degree junction are PANDA-type fibers each having a core and a pair of stress rods disposed on opposite sides of said core, said two of the optical fiber segments being aligned along the linear cavity with their respective stress rods at a 90-degree rotation angle relative to each other.

7. The light pulse generator according to claim 1, wherein at least one of the optical fiber segments of the optical fiber path is configured to avoid crosstalk between said orthogonal principal axes without inducing birefringence.

8. The light pulse generator according to claim 1, wherein the first FBG is a Low Reflectivity FBG (LR-FBG) and the second FBG is a High Reflectivity FBG (HR-FBG).

9. The light pulse generator according to claim 1, wherein the first FBG is a High Reflectivity FBG (HR-FBG) and the second FBG is a Low Reflectivity FBG (LR-FBG).

10. The light pulse generator according to claim 1, wherein the first and second FBGs each have a slow axis reflectivity profile and a fast axis reflectivity profile, a spectral spacing between the slow axis reflectivity profile of the first FBG and the fast axis reflectivity profile of the second FBG being shorter than a spectral spacing between the fast axis reflectivity profile of the first FBG and the slow axis reflectivity profile of the second FBG.

11. The light pulse generator according to claim 1, wherein the first FBG has a first reflectivity profile and the second FBG has a second reflectivity profile detuned from the first reflectivity profile, the linear cavity being configured as a Mamyshev Oscillator.

12. The light pulse generator according to claim 1, wherein the first and second FBGs each has a corresponding reflective spectral band, the reflective spectral bands of the FBGs substantially overlapping, thereby defining an overlap spectral range, said light pulse generator further comprising a blocking filter positioned between the FBGs and configured to remove light at wavelengths within a blocking spectral range from the optical path, the blocking spectral range including at least the overlap spectral range.

13. A light pulse generator, comprising:
a linear cavity free of polarizing components and configured to generate, based on spectral broadening of light, ultrashort light pulses having a pre-defined polarization, comprising:
an optical fiber path comprising a plurality of consecutive optical fiber segments each configured to guide polarized light such that the polarization of the polarized light is aligned with one of two orthogonal principal axes, two or more of said optical fiber segments consisting of segments of polarization maintaining optical fibers;
first and second Fiber Bragg gratings (FBGs) disposed at opposite extremities of the optical fiber path and respectively hosted in a first and a second FBG-hosting optical fiber segment from said plurality of optical fiber segments, at least the first FBG-hosting optical fiber segment being one of said segments of polarization maintaining optical fibers and having a birefringence defining a slow polarization axis and a fast polarization axis as said orthogonal principal axes; and
at least one optical gain region positioned in the optical fiber path between the FBGs;
wherein two consecutive ones of said segments of polarization maintaining optical fibers are coupled together with a 90-degree junction between their respective principal axes.

14. The light pulse generator according to claim 13, wherein said 90-degree junction is a fusion splice.

15. The light pulse generator according to claim 13, wherein said segments of polarization maintaining optical fibers are PANDA-type fibers, bow-tie fibers, photonic crystal fibers having a birefringence-inducing arrangement of air holes, flattened optical fibers or coiled optical fibers with a birefringence-inducing coiling or combinations thereof.

16. The light pulse generators according to claim 13, wherein said two consecutive ones of said segments of polarization maintaining optical fibers coupled together with a 90-degree junction are PANDA-type fibers each having a core and a pair of stress rods disposed on opposite sides of said core, said two of the optical fiber segments being aligned along the linear cavity with their respective stress rods at a 90-degree rotation angle relative to each other.

17. The light pulse generator according to claim 13, wherein at least one of the optical fiber segments of the optical fiber path is configured to avoid crosstalk between said orthogonal principal axes without inducing birefringence.

18. The light pulse generator according to claim 13, wherein the first FBG has a first reflectivity profile and the second FBG has a second reflectivity profile detuned from the first reflectivity profile, the linear cavity being configured as a Mamyshev Oscillator.

19. The light pulse generator according to claim 13, wherein the first and second FBGs each has a corresponding reflective spectral band, the reflective spectral bands of the FBGs substantially overlapping, thereby defining an overlap spectral range, said light pulse generator further comprising a blocking filter positioned between the FBGs and configured to remove light at wavelengths within a blocking spectral range from the optical path, the blocking spectral range including at least the overlap spectral range.
